(19) United States
(12) Patent Application Publication
(10) Pub. No.: US 2010/0068428 A1
(43) Pub. Date: Mar. 18, 2010

(54) Method for Producing Hollow Shaft Base Bodies and Hollow Shaft Base Body Produced Thereby

(75) Inventor: Matthias Derse, Elzach (DE)

Correspondence Address: CROWELL & MORING LLP;INTELLECTUAL PROPERTY GROUP, P.O. BOX 14300, WASHINGTON, DC, 20044-4300, US

(73) Assignee: Neumayer Tekfor Holding GmbH, Hausach (DE)

(21) Appl. No.: 12/626,119

(22) Filed: Nov. 25, 2009

Related U.S. Application Data
(63) Continuation of application No. PCT/DE2008/000833, filed on May 15, 2008.

(30) Foreign Application Priority Data
May 26, 2007 (DE) 10 2008 024 743.7

(51) Int. Cl. B29D 23/00; B21D 3/00

(52) U.S. Cl. 428/34.1; 72/367.1

(57) ABSTRACT

A method of producing a hollow shaft base body including a first step in which a perform (1a) having a transition diameter and a bore (4a) is produced by shaping, and an additional step in which the perform is shaped incrementally to form the hollow shaft base body (1b), and a hollow shaft base body produced by the foregoing method.

### CROSS REFERENCE TO RELATED APPLICATIONS

This application is a continuation of international patent application no. PCT/DE2008/000833, filed May 15, 2008 designating the United States of America and published in German on Dec. 4, 2008 as WO 2008/145092, the entire disclosure of which is incorporated herein by reference. Priority is claimed based on Federal Republic of Germany patent application no. DE 10 2007 024 743.7, filed May 26 2007.

### BACKGROUND OF THE INVENTION

EP 1 745 870 A1 discloses a method for producing hollow shaft base bodies in which in a first step the outer surface of a cylindrical starting material is processed by deformation in order to obtain at least one pre-determined diameter transition in the longitudinal direction of a base body. During this first step, specifically carried out by means of a cross wedge rolling process, a bore is also formed in the body by means of one or two mandrels. Then, in a further method step, specifically by incremental deformation, the outer and/or inner surface of the base body is produced.

Apart from the fact that it appears doubtful that the cross wedge rolling and the introduction of at least one mandrel from at least one side to create at least one bore could be performed simultaneously, the method described in this document also suffers from significant disadvantages, in particular, the disadvantages that tools which are both expensive and complex to develop are required for carrying out the cross wedge rolling and that the cycle times that can be achieved are high so that only small numbers of product per unit time can be achieved. The argument regarding conserving resources set out in the European published unexamined application may be valid for the possibility, given as an alternative, of producing the bore by extrusion (during extrusion, only a relatively small slug is left as waste). However, cross wedge rolling is itself not ideal from the standpoint of conserving resources since, as is known, at the end of each cross wedge rolling process, the material pushed over the active tool length must subsequently be sheared off at both ends of the shaft and is then left over as waste. The resource situation is worsened if—as described as a further possible solution—the bore is made before or after the cross wedge rolling process by cutting (wherein it is unclear whether this process should be regarded as a further step).

### SUMMARY OF THE INVENTION

It is an object of the present invention to overcome the aforementioned disadvantages and to ensure easier and more economical production of a hollow shaft base body.

It is also an object of the invention to further optimize resource conservation in the production of a hollow shaft base body.

Another object of the invention is to provide a method of producing hollow shaft base bodies which avoids expensive development of tools while significantly improving productivity.

A further object of the invention is to provide a method of producing a hollow shaft base body which provides a blank of the best possible quality for subsequent processing steps.

An additional object of the invention is to provide a method of producing a hollow shaft base body in which the creation of the bore takes place such that, for most applications, further machining thereof is not required inasmuch as bores can be created such that subsequent alignment of the bore due to wandering of a mandrel is no longer necessary.

The method of the invention for producing hollow shaft base bodies having at least one bore is characterized in that:

in a first step in which both the outer surface of a cylindrical starting material and the bore are machined by deforming to a preform or blank, at least one pre-determined diameter transition is generated in the longitudinal direction of the preform, and

in a further step, the preform is formed by deforming the outer and/or inner surface of the base body incrementally to the hollow shaft base body.

By producing a preform or a blank by deforming, wherein for the vast majority of applications, a forging process is particularly suitable, the blanks can be produced in simple tools and provided with a bore and then serve as the starting product for the further step. The bore can either be introduced only partly into the base body or it can extend all the way through the body. Even with a through bore, only a little waste is produced by the stamping out of the slug which is suitably part of the forging process. A particularly favorable large-scale serial production is made possible by the use of forging tools. The previously mentioned stamping out of the slug can also take place in a separate operation in a tool outside the forging tool. The deforming to a preform can also take place in a deformation process which is carried out semi-hot or—for example, depending on the required degree of deformation or the application—cold.

For a further step, wherein the perform produced in this manner is further deformed, specifically the inner and/or outer surface is deformed, rotary swaging is particularly advantageous and this can be cold or semi-hot rotary swaging, depending on the application or the product. In this way, a geometry which approaches the final contour can be created in a particularly economical manner and with maximum material utilization. This also involves an optimum and uninterrupted grain flow, so that the loading capacity is favorably influenced. During this second operational step, the bore of at least one of the hollow shaft ends can be closed in a particularly favorable manner by the incremental process.

The invention also relates to hollow shafts, for example, gearbox shafts, which are produced through the inventive combination of at least one of the patentable method steps set out in the claims, wherein the shaft may comprise a through bore or merely a partial bore.

It can also be advantageous if, during the first step for producing the preform, the preform is provided with an undercut. This can be achieved, for example, in that during the forging process, a slide tool is used in one of the forging steps, the slide tool comprising a plurality of segments which are movable toward the body to be forged and are brought together for the pressing procedure and are moved apart again for ejecting the part.

### BRIEF DESCRIPTION OF THE DRAWINGS

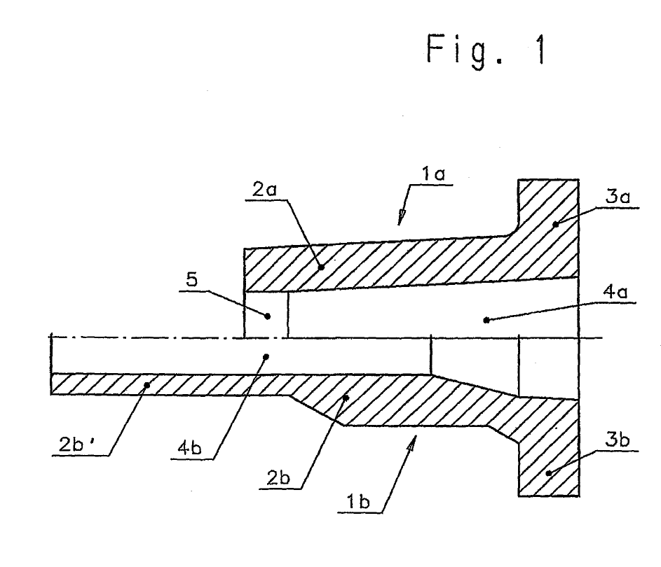

The invention will be described in further detail hereinafter with reference to illustrative preferred embodiments shown in the accompanying drawing FIGS. 1-3, in which the upper half of each figure shows a preform from which a hollow shaft contour is formed according to the invention, and the lower half of each figure shows the hollow shaft contour made from the respective perform.

### DETAILED DESCRIPTION OF PREFERRED EMBODIMENTS

In FIG. 1, the preform la comprises a shaft section 2a and a flange section 3a as well as a through bore 4a. The shaft region and the bore can be configured cylindrically or conically.

The preform 1a is produced by a forging process which is carried out in a multistage tool. In one of the sequences, the bore 4a is introduced as far as a slug 5. This slug is either stamped out in a subsequent station or can be stamped out in a tool outside the forging tool.

In a second step, the preform la is formed into the hollow shaft body 1b and this process is carried out incrementally as, for example, with rotary swaging. In this process, the flange region 3a can be largely retained and the incremental deformation can be carried out in the region adjoining the region 3b. Depending on the desired inner contour 4b, by suitable preforming of the region 2b and 2b′, a cylindrical or profiled mandrel can be inserted from the side facing away from the flange region 3a.

The region 2b′ can be narrowed by incremental deformation such that the bore 4b is closed at its end region.

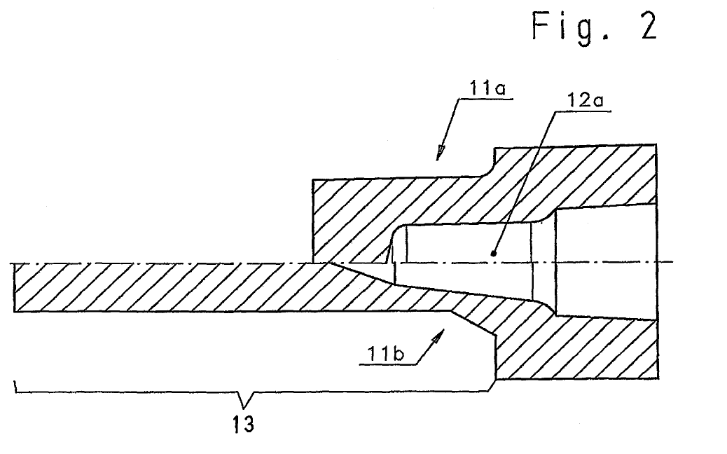

FIG. 2 shows another embodiment according to the invention wherein the upper region 11a of FIG. 2 represents the preform and the lower region represents the hollow shaft base body 11b. The bore 12a introduced during the forging process extends only partially through the blank 11a and the region formed by incremental deformation is identified as 13.

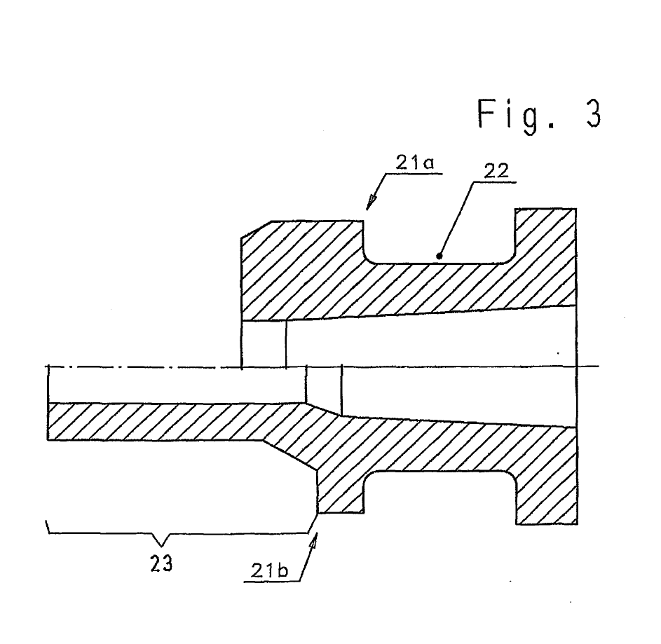

In FIG. 3, the preform 21a made by forging is provided with an undercut 22 which is made by forging together with the blank 21a.

The hollow shaft base body 21b shown in the lower region of FIG. 3 is deformed in the region 23 by rotary swaging. Depending on the internal form desired, the region 23 can be supported by a mandrel during the deforming process.

The foregoing description and examples have been set forth merely to illustrate the invention and are not intended to be limiting. Since modifications of the described embodiments incorporating the spirit and substance of the invention may occur to person skilled in the art, the invention should be construed broadly to include all variations within the scope of the appended claims and equivalents thereof.

1. A method for producing A hollow shaft base body provided with a bore, said method comprising:
a first step in which both the outer surface of a cylindrical starting material is processed by deformation into a preform, wherein at least one pre-determined diameter transition is generated in the longitudinal direction of the preform, and a bore extending at least partially therethrough is generated, and
a further step in which the preform is formed, by deforming the outer and/or inner surface of the base body incrementally, to the hollow shaft base body.

2. A method as claimed in claim 1, wherein the second step is rotary swaging.

3. A method as claimed in claim 1, wherein the preform is provided with an undercut during the first step.

4. A method as claimed in claim 1, wherein the deformation to a preform is carried out in a semi-hot condition.

5. A method as claimed in claim 1, wherein the deformation to a preform is carried out in a cold condition.

6. A method as claimed in claim 1, wherein the incremental deformation is carried out in a semi-hot condition.

7. A method as claimed in claim 1, wherein the deformation in the further step is carried out cold.

8. A method as claimed in claim 1, wherein at least one of the hollow shaft ends of the preform is closed again by incremental deformation.

9. A hollow shaft wherein a base body thereof provided with a bore:
is processed to a preform in a first step in which both the outer surface of a cylindrical starting material and the bore are processed by deformation, wherein at least one pre-determined diameter transition is generated in the longitudinal direction of the preform, and
the hollow shaft base body is deformed in a further step in which the preform is formed by incremental deformation of the outer and/or inner surface of the base body into the hollow shaft base body.

10. A hollow shaft as claimed in claim 9, wherein the bore extends entirely through the shaft.

11. A hollow shaft as claimed in claim 9, wherein the bore extends only partially through the shaft.

12. A hollow shaft as claimed in claim 9, wherein at least one of the hollow shaft ends of the preform is closed by incremental deformation.
